(19) United States
(12) Patent Application Publication
(10) Pub. No.: US 2017/0084085 A1
(43) Pub. Date: Mar. 23, 2017

(54) SYSTEM AND METHOD FOR OBJECT RECOGNITION

(71) Applicant: Caterpillar Inc., Peoria, IL (US)

(72) Inventor: Drew Solorio, Elmwood, IL (US)

(73) Assignee: Caterpillar Inc., Peoria, IL (US)

(21) Appl. No.: 15/364,911

(22) Filed: Nov. 30, 2016

(51) Int. Cl. G06T 19/00; G06F 17/50; G06T 19/20

(52) U.S. Cl. CPC G06T 19/006; G06T 19/20; G06F 17/50; G06T 2219/2004

(57) ABSTRACT

A method of recognizing an object for applying an augmented reality image is provided. The method includes converting 3D CAD drawings of a plurality of objects to associated point cloud data. The method also includes storing the point cloud data associated with the 3D CAD drawings in a database. The method includes identifying the object by scanning a portion of an object. The method also includes retrieving point cloud data associated with the object. The method further includes comparing the image feed of the object with the point cloud data for aligning the point cloud data with the image feed of the object. The method includes retrieving and aligning a corresponding 3D CAD drawing associated with the point cloud data of the object. The method also includes overlaying the 3D CAD drawing associated with the object on the image feed of the object on the portable computing device

### TECHNICAL FIELD

The present disclosure relates to an augmented reality application, and more particularly to a system and method for recognizing an object for applying an augmented reality image.

### BACKGROUND

Sometimes, it may be required to overlay an Augmented Reality (AR) image on portions of physical 3-Dimesnional (3D) objects, such as machines. In order to correctly position and overlay the AR image over a live image feed of the 3D objects, a portable computing device is required to scan the 3D object in real world. This portable computing device may include image capturing assemblies such as cameras and/or other sensors such as infrared sensors to scan an entire geometry of the 3D object for creating corresponding point cloud data of the 3D object. After the point cloud data is created, the AR image may be overlaid by the portable computing device on the live image feed of the 3D object. This overlay may be visible to a user on a display of the portable computing device, such that the background includes the live image feed of the 3D object and the AR image is superimposed on the live image feed. The AR image is viewable on a display of the portable device.

Object recognition systems that support AR require real time scanning of the 3D object in order to produce the digital point cloud representation of that object. The digital point cloud representation captures key feature points of the 3D object to invoke AR experiences. Since this processing, including scanning of the 3D object and overlaying of the AR image takes place in real time, processors having extremely high processing speeds for rapidly processing high volumes of data are required to make the AR experience seamless with reality. Otherwise, there may be delays or time lags due to slow processing of the enormous volumes of real time data. Such systems may be hardware dependent and costly.

Further, sometimes due to low light or ambient conditions, the object recognition or computer vision systems may not be able to accurately capture certain portions of the 3D object. The user may need to spend excess time in scanning and re-scanning certain portions of the 3D object for generation of accurate point cloud data. This may be a time consuming and laborious process for the user of the system, which may otherwise lead to inaccurate recreation of the 3D object. Hence, there is a need for an improved object recognition method for AR applications.

### SUMMARY OF THE DISCLOSURE

In one aspect of the present disclosure, a method of recognizing an object for applying an augmented reality image is provided. The method includes converting, by a controller, 3-Dimesnional (3D) Computer-Aided Design (CAD) drawings of a plurality of objects to associated point cloud data. The method also includes storing, by the controller, the point cloud data associated with the 3D CAD drawings in a database. The method further includes capturing, by an image capturing assembly, an image feed of an object, wherein the object belongs to the plurality of objects. The method includes identifying, by the controller, the object by scanning a portion of an object. The method also includes retrieving, by the controller, point cloud data associated with the object from the database based on the identification. The method further includes comparing, by the controller, the image feed of the object with the point cloud data for aligning the point cloud data with the image feed of the object. The method includes eying and aligning, by the controller, a corresponding 3D CAD drawing associated with the point cloud data of the object based on the comparison. The method also includes overlaying, by the controller, the 3D CAD drawing associated with the object on the image feed of the object on the portable computing device.

Other features and aspects of this disclosure will be apparent from the following description and the accompanying drawings.

### BRIEF DESCRIPTION OF THE DRAWINGS

FIG. 1 is a perspective view of an exemplary machine and a user holding a portable computing device, according to various concepts of the present disclosure;

FIG. 2 is a block diagram of the portable computing device of FIG. 1, according to various concepts of the present disclosure; and

FIG. 3 is a flowchart of a method for recognizing an object for applying an augmented reality image, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

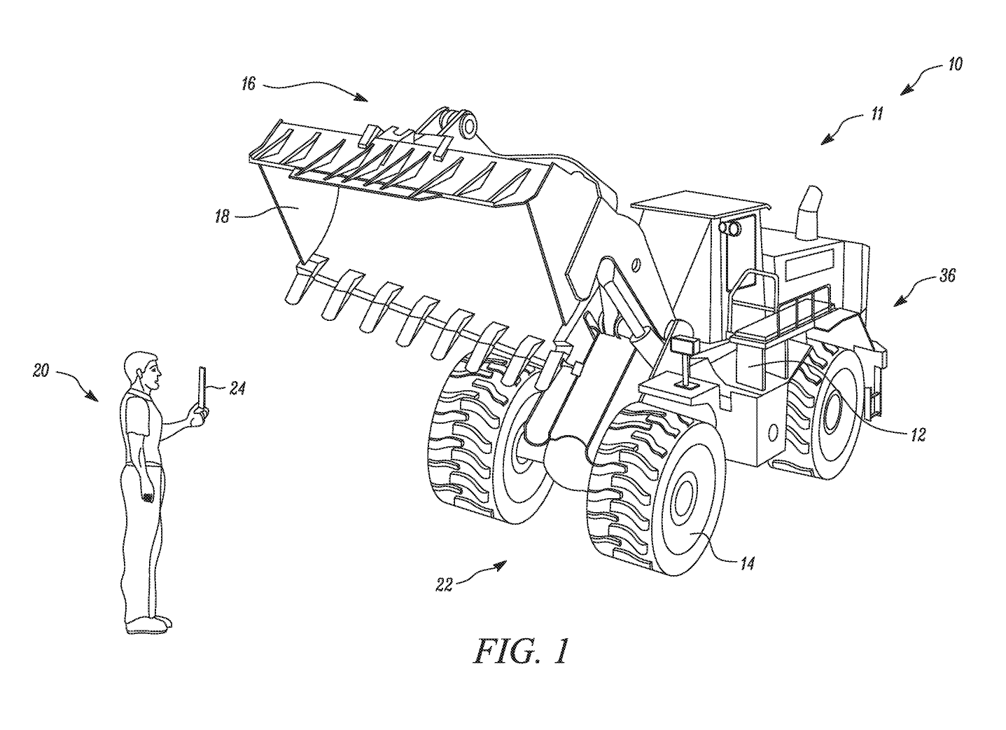

Referring to FIG. 1, the present disclosure relates to a portable means to recognize an object 10 for applying an Augmented Reality (AR) image. The object 10 may include any 3-Dimesnional (3D) physical object, without limiting the scope of the present disclosure. In the illustrated embodiment, the object 10 is embodied as a machine 11.

The machine 11 is embodied as a wheel loader. Alternatively, the machine 11 may include any other earthmoving machine or stationary machine such as a motor grader, an excavator, a tractor, a skid steer loader, a generator, etc. The machine 11 includes a frame 12. A powertrain including a power source (not shown) is located within an enclosure of the machine 11. The power source may include one or more engines or other power delivery systems such as batteries, hybrid engines, and the like.

The machine 11 also includes wheels 14 for the purpose of mobility. The powertrain may also include a transmission system provided between the power source and the wheels 14 for transmission of the motive power. A linkage assembly 16 is attached to the frame 12 of the machine 11. The linkage assembly 16 includes an implement 18, such as a bucket.

Further, a user 20 is shown standing proximate to a front portion 22 of the machine 11. The user 20 is shown holding a portable computing device 24. The portable computing device 24 may include for example, a tablet, a smartphone, a mobile computing device, a netbook, or any other handheld computer vision system known in the art. Alternatively, the portable computing device 24 may include an AR headset or helmet worn by the user 20.

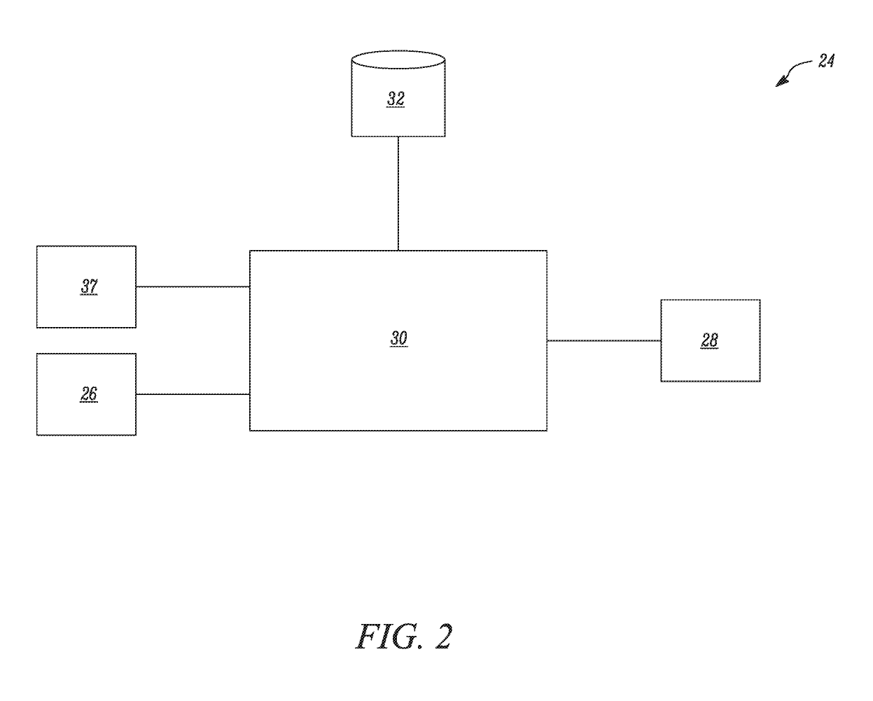

Referring to FIG. 2, the portable computing device 24 has an image capturing assembly 26. The image capturing assembly 26 captures an image feed of the machine 11 (see FIG. 1). The image capturing assembly 26 may capture the image feed of one or more portions of the machine 11. In the illustrated embodiment, the image capturing assembly 26 captures the image feed of the front portion 22 (see FIG. 1) of the machine 11.

Further, the image capturing assembly 26 may also capture a video feed of the machine 11, based on system requirements. The image capturing assembly 26 may include any known imaging or video device, for example, a camera provided on the portable computing device 24 for capturing image or video feed. The image capturing assembly 26 is positioned on a rear side of the portable computing device 24 such that the image capturing assembly 26 can be aimed at the machine 11. The image feed of the machine 11 is visible on a display 28 of the portable computing device 24. The display 28 may include any one of a touchscreen, a screen, or other display unit to display the different views of the machine 11 as captured by the image capturing assembly 26, Further, the portable computing device 24 may include an input unit 37 such as, the touchscreen, a keypad, and so on to allow the user 20 to feed or provide information to a controller 30 of the portable computing device 24.

In the present disclosure, the functionality of object recognition and image analysis performed by the controller 30 for augmenting the AR image on the machine 11 while the user 20 has activated the image capturing assembly 26 of the portable computing device 24 may be accomplished after the user 20 logs into or opens a web application or other online application at the time the user 20 triggers this functionality on the portable computing device 24. The controller 30 may either download or execute the application in real time.

Prior to capturing the image feed for the specific application, the controller 30 of the portable computing device 24 and other similar controllers that are present on other devices may have previously converted 3D Computer-Aided Design (CAD) drawings of a number of different objects in to their corresponding point cloud data. This conversion of the 3D CAD drawings to the point data cloud may have taken place on a need or demand basis and need not be conducted locally on a single portable computing device. For example, 3D CAD drawings including different views of the given machine 11 and also those of other machines may have been previously made and converted to the point cloud data representation for a pool of the portable computing devices that require this information on a regular or recurring basis.

The controller 30 may convert the 3D CAD drawings into the point cloud data and maintain corresponding relationships between the point cloud data and the 3D CAD drawings for later use or retrieval by other portable computing devices that have rights or permissions to access this information through authorization based on logging into the application. This information may be stored in a database 32 that includes online or offline data repository, external data source and/or cloud. The database 32 may include a single consolidated database or multiple databases based on the needs of the system. The 3D CAD drawings of a number of different types of machines and the corresponding converted point cloud data for the 3D CAD drawings is pre-stored in the database 32 for later use. At the time of use, this information may be accessed through wireless data communication between the controller 30 of the portable computing device 24 and the database 32.

When the user 20 standing in front of the machine 11 logs into the application and captures the image feed of the machine 11, this feed of the front portion 22 of the machine 11 is received by the controller 30. The controller 30 may make use of a machine learning algorithm to scan and analyze the image feed for identifying at type of the machine 11. In some examples, the controller 30 may also receive an image teed of an identification code, such as a Quick Response (QR) code, present on the machine 11. In such an example, the controller 30 may use the image feeds of the machine 11 and the QR code for identifying the machine 11 in the captured image feed. Alternatively, the controller 30 may identify the type of the machine 11 based on scanning or performing image analysis on any other portion of the machine 11.

Based on the type of the machine 11 identified by the controller 30, the controller 30 accesses the database 32 through a wireless data communication network, such as Wi-Fi, Wi-Fi Direct, Bluetooth, etc. to retrieve the point cloud data associated with the machine 11. The retrieved point cloud data is displayed on the display 28 of the portable computing device 24. More particularly, based on the identification, the controller 30 selects the corresponding point cloud data relevant to the machine 11 and overlays the point cloud data on the image feed of the machine 11.

Further, the controller 30 may utilize object recognition and image analysis on the image teed and compare the image feed of the machine 11 with the point cloud data for aligning the point cloud data displayed on the display 28 of the portable computing device 24 with the image feed of the machine 11 that is present in the background such that the point cloud data associated with the machine 11 coincides with that in the image feed.

In some examples, the image capturing assembly 26 may not be oriented or positioned correctly to capture the front portion 22 of the machine 11, as detected by the controller 30 based on the image analysis performed on the image feed. In such examples, the controller 30 may give directions to the user 20 on how to re-orient the portable computing device 24 with respect to the machine 11 to capture an optimum view of the machine 11. In such cases, after the point cloud data is overlaid on the portable computing device 24, the controller 30 may align or re-align the point cloud data based on the re-positioning of the portable computing device 24 in 3D space that is conducted by the user 20 to ensure that the point cloud data aligns with the background image feed of the machine 11.

Based on the comparison and alignment of the point cloud data with the image teed of the machine 11, the controller 30 retrieves and/or generates the corresponding 3D CAD drawing associated with the point cloud data of the machine 11 from the database 32. Further, the controller 30 compares the image feed of the machine 11 with the 3D CAD drawing for aligning the 3D CAD drawing with the image feed of the machine 11 such that the 3D CAD drawing coincides with the image feed of the machine 11. The controller 30 overlays the 3D CAD drawing associated with the point cloud data of the machine 11 on the display 28 based on the alignment of the image feed with the 3D CAD drawing. More particularly, the controller 30 overlays the 3D CAD drawing as the AR image associated with the machine 11 on the image feed of the machine 11 on the display 28 of the portable computing device 24.

In some examples, the controller 30 may retrieve more than one 3D CAD drawing associated with the point cloud data from the database 32. More particularly, for the front portion 22 of the machine 11, such multiple results may be a result of differences in shape, features, and/or characteristics of the front portion 22 of the machine 11 with that of the previously stored data in the database 32, In such an example, the controller 30 may prompt the user 20 to select one of the retrieved 3D CAD drawings that closest corresponds to that of the machine 11. Based on the input provided by the user 20 via the input unit 37, the controller 30 selects the corresponding the 3D CAD drawing for overlay on the image feed of the machine 11. The controller 30 overlays the 3D CAD drawing as the AR image on the image feed of the machine 11.

Additionally, or optionally, the controller 30 refreshes and realigns the overlay of the 3D CAD drawing to ensure that the 3D CAD drawing coincides with that of the machine 11 in the image feed. This refreshment and realignment may be required based on a change in orientation of the machine 11 in the image feed or movement in the portable computing device 24 caused by the user 20.

The controller 30 may embody a single microprocessor or multiple microprocessors. Numerous commercially available microprocessors can be configured to perform the functions of the controller 30. The controller 30 may include all the components required to run an application such as, for example, a memory, a secondary storage device, and a processor, such as a central processing unit or any other means known in the art. Various other known circuits may be associated with the controller 30, including power supply circuitry, signal-conditioning circuitry, solenoid driver circuitry, communication circuitry, and other appropriate circuitry.

### INDUSTRIAL APPLICABILITY

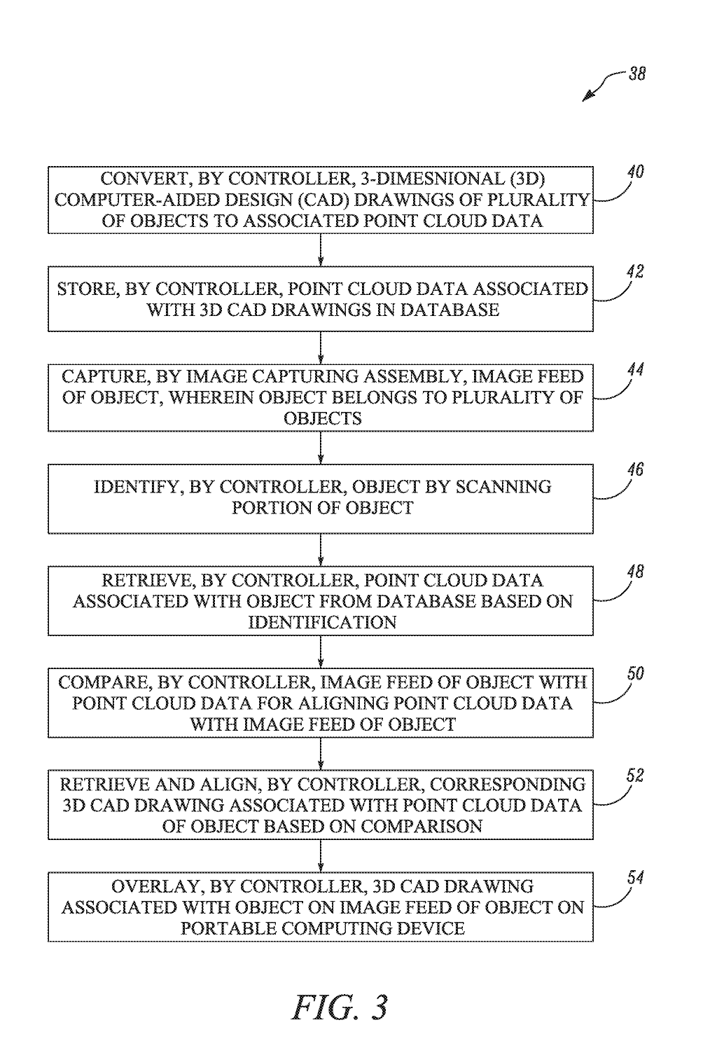

The present provides a system and a method 38 of recognizing the object 10 for applying the AR image. In this embodiment, the object 10 is embodied as the machine 11. Referring to FIG. 3, at step 40, the controller 30 converts the 3D CAD drawings of the number of machines to associated point cloud data. At step 42, the point cloud data associated with the 3D CAD drawings is stored by the controller 30 in the database 32. At step 44, the image capturing assembly 26 captures the image feed of the machine 11, wherein the machine 11 belongs to the number of machines. At step 46, the controller 30 identifies the machine 11 by scanning the portion of the machine 11.

At step 48, the controller 30 retrieves the point cloud data associated with the machine 11 from the database 32, based on the identification. At step 50, the controller 30 compares the image feed of the machine 11 with the point cloud data for aligning the point cloud data with the image feed of the machine 11. At step 52, the controller 30 retrieves and aligns the corresponding 3D CAD drawing associated with the point cloud data of the machine 11, based on the comparison. At step 54, the controller 30 overlays the 3D CAD drawing associated with the machine 11 on the image feed of the machine 11 on the portable computing device 24. Further, the controller 30 also refreshes and realigns the overlay of the 3D CAD drawing based on the change in orientation of the machine 11 in the image feed.

The present disclosure provides a simple, easy, and cost-effective technique for applying the AR image on the image feed of various 3D objects. Further, the 3D CAD drawings of the number of objects are converted into associated point cloud data and pre-stored in the database 32. The system provides a rapid method for generating and overlaying the 3D CAD drawing on the object by making use of previously converted point cloud data. This utilization of previously converted CAD geometry may increase an overall accuracy of the process. By logging into the application, real world objects can be used to reference the pre-stored point cloud data associated with the relevant objects to match the real world object with their 3D modeled counterparts in a quick and efficient manner.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed, Such embodiments should be understood to fall within the scope of the present disclosure as determined based upon the claims and any equivalents thereof.

What is claimed is:

1. A method of recognizing an object for applying an augmented reality image, the method comprising:
converting, by a controller, 3-Dimesnional (3D) Computer-Aided Design (CAD) drawings of a plurality of objects to associated point cloud data;
storing, by the controller, the point cloud data associated with the 3D CAD drawings in a database;
capturing, by an image capturing assembly, an image feed of an object, wherein the object belongs to the plurality of objects;
identifying, by the controller, the object by scanning a portion of an object;
retrieving, by the controller, point cloud data associated with the object from the database based on the identification;
comparing, by the controller, the image feed of the object with the point cloud data for aligning the point cloud data with the image feed of the object;
retrieving and aligning, by the controller, a corresponding 3D CAD drawing associated with the point cloud data of the object based on the comparison; and
overlaying, by the controller, the 3D CAD drawing associated with the object on the image teed of the object on the portable computing device.

2. The method of claim 1 further comprising refreshing and realigning, by the controller, the overlay of the 3D CAD drawing based on a change in orientation of the object in the image feed.
